(19) United States
(12) Patent Application Publication
(10) Pub. No.: US 2004/0080071 A1
(43) Pub. Date: Apr. 29, 2004

(54) Thermoplastic composite decking profile of continuous fiber reinforcement

(76) Inventors: Byeong H. Jo, Blue Bell, PA (US); John B. Peavey, Maple Shade, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/281,796

(22) Filed: Oct. 28, 2002

(51) Int. Cl. B29C 70/50; B29C 70/52

(52) U.S. Cl. 264/136; 264/171.13

(57) ABSTRACT

The present invention relates to a process for providing a consolidated form of the commingled continuous filaments of glass fibers and polymeric fibers as reinforcement. The consolidation of the commingled fibers into composite reinforcement can be used in a continuous form or bulk molding compound pellets. The consolidation of the commingled fibers into composite reinforcement can be made in-situ during in-line extrusion of the final end product extrudate, or prepared as a tape or rod and incorporated into an off-line extrusion of final product. The bulk molding pellets are used solely or diluted with an addition of polymeric material for mono or co-extrusion or compression molding.

### FIELD OF THE INVENTION

The present invention relates to a process for providing a consolidated form of the commingled continuous filaments of glass fibers and polymeric fibers as reinforcement in composite decking.

### BACKGROUND OF THE INVENTION

Most fence and rail materials are either traditional lumber or thermoplastics. Typical plastics in these applications are PVC (polyvinyl chloride) and polyethylene. PVC typically does not have the strength and rigidity of wood and lumber and therefore, the rail for the fence and railing needs the steel or aluminum reinforcement channel inside the rail. These metal reinforcements are prone to corrosion attack, and lose strength in long-term endurance. Also, the problem exists as to the dark color of thermoplastic products. The dark color fence and rail made out of PVC or other polymeric materials has not been successful in the past. The products show bowing due to differences in expansion and contraction between the two different sides of the product upon exposure of sunlight. In addition, the dark color absorbs heat readily and the resultant uneven heat buildup causes this deformation. An additional problem is the lack of long-term stiffness of the products. It has limited the rail span between the posts to less than traditional lumber.

Thus, synthetic decks, whether composed of plastic or wood-plastic composite materials, do not fully satisfy market needs.

Wood-plastic composite planks are produced by extrusion, and the extrusion has various limitations. Extrusion uses an embossing roll to create a wood grain surface. The quality of such wood grains is often not particularly high. Furthermore, the wood composite deck planks are heavy, since the wood composite has a lower modulus and flexural strength, needing a thick wall to compensate for these strength levels. In addition, the wood composite deck does not have color fastness; it changes color from natural or gray to silver-gray over time, in a non-uniform manner when exposed to the outdoor environment.

As noted above, there is another class of synthetic deck planks available, namely the PVC profile decks. Such decks are produced by profile extrusion. In this type of production, it is often difficult to use an embossing roll to create the wood grain texture in a uniform nature on the deck surface. The pressure imposed by the embossing roll often cannot provide a uniform force, because the surface of a hollow and three-dimensional panel responds in a non-uniform manner to the particular force. As result, a “real wood” grain emulated surface is particularly difficult to achieve. The PVC profile deck also has a significant thermal expansion coefficient; installation requires care in order to accommodate the expansion and contraction of changes in temperature. In this regard, the dark color deck panel materials have not been practical, since the heat build-up on the surface is more pronounced for darker colored panels. Regarding color fastness, the darker color PVC is superior to wood-plastic composites, but still has the tendency to lose its original color to a visible degree. Furthermore, PVC has a tendency to become brittle with aging upon outdoor exposure, resulting in a loss of its impact strength.

The present invention serves to correct the shortcomings noted above. The deck panel produced in accordance with the present invention has superior resistance to color fading, possesses superior cold impact strength, has a well-defined wood grain surface, and is lightweight.

One of the objectives of the present invention is the production of a high strength plastic alternative to the traditional wrought iron or aluminum ornamental rail and fence. Metal fences and rails are constantly under the threat of corrosion attack, and need periodic painting. To date, there have not been any non-composite products with the necessary performance properties and aesthetic appearance comparable to these metal products. In that sense, there have not been any thermoplastic composite products in the market. The present invention discloses thermoplastic composite products that resemble wrought iron, and aluminum wrought iron alternative, but are maintenance-free, kink-free, light and perform equally as well.

An additional objective is to make the dark color thermoplastic post and rail fence (e.g., split post and rails) possible. The fiberglass reinforcement stabilizes the uneven contraction and expansion, in spite of different heat buildup on the surface.

A further objective of the present invention is providing non-metallic heavy duty rail and fence systems for use in industrial and commercial applications. The metallic railing in an industrial atmosphere is often exposed to chemical gases or acids and is prone to corrosion attack. The integrity of the industrial railing is critical for the safety of those in the workplace. The thermoplastic railing system that is strengthened by reinforcing tapes or rods of fiberglass/thermoplastic polymer composite provides superior strength and rigidity to its metal counterparts.

### BRIEF DESCRIPTION OF THE DRAWINGS

FIG. 1 is a front perspective view of a deck construction using the preferred composite.

FIGS. 2 and 3 are front perspective views of alternative deck constructions.

### DESCRIPTION OF THE PREFERRED EMBODIMENTS

The present invention relates to a process for providing a thermoplastic composite decking profile of continuous fiber reinforcement. The consolidation of commingled fibers into composite reinforcement may be made in-situ during in-line extrusion of the final end product extrudate, or, alternatively, prepared as a tape or rod and incorporated into an off-line extrusion of final product. In either case, the materials of the present invention are incorporated through a cross-head die into the polymer extrudate. In this way, the matrix polymer encapsulates the inside and outside surface of the hollow profile product.

Another production process is to subject these commingled fibers through pultrusion and its die, followed by overlay extrusion of a cap stock polymer using a separate extruder, all in-line. In this case, the capstock polymer covers only the outside surface. The commingled fibers are heated prior to entering into the series of forming dies where they are consolidated. In a further embodiment, a helical winding machine may be added in order to enhance the strength in the hoop direction before the die entrance.

A preferred material for use in the present invention is Twintex™ composite tapes, supplied by the Saint-Gobain Corporation. The Twintex materials are present in various forms, such as commingled roving and fabrics (uni-directional, or multi-axial woven fabric or tapes). The commingled roving is consolidated through a pultrusion die into a thermoplastic composite tape or rod. It contains glass fibers dispersed uniformly in a longitudinal direction. The polymeric fiber that becomes the consolidation matrix may be either polyethylene (PE), polypropylene (PP) or polyesters (PBT or PET). The functional need of the end product and extrusion process will determine the fiberglass contact in the Twintex material and the volume of the consolidated reinforcement. A “standard” Twintex material contains about 40%-75% glass fiber content.

Although polyethylene and polypropylene Twintex tapes were used in the testing of the present invention, any polymeric materials would be acceptable to be a commingled fiber with glass fiber, as long as they are capable of being fiberized and made compatible to the intended matrix polymers.

A further aspect of the present invention relates to the compatibility of the commingled polymeric fiber material with the matrix polymer of the final extrusion product. These materials need adhesion with each other in order to be effective. In the testing of the present invention, a polyethylene-glass fiber Twintex reinforcement/HMPE polymer, polypropylene-glass fiber Twintex reinforcement HMPE polymer, polyethylene-glass fiber Twintex reinforcement/polyethylene polymer, and polypropylene glass fiber Twintex reinforcement/polyethylene polymer were used. The combinations of the polymers of the composite reinforcement and the base polymers are numerous, and may be customized in order to meet the needs of the final product performance requirements.

The Twintex composite reinforcement allows for the base polymeric material with a higher impact in both cold and ambient temperatures, lower heat expansion coefficient, higher tensile and flexural strength, as well as higher rigidity. These Twintex reinforcements (rods, tapes or fabrics) are embedded into strategic locations of the basic polymeric material.

In a further preferred embodiment of the present invention, a hybrid of Twintex filaments with carbon fibers may be utilized, with the combination providing for higher stiffness and for easier material handling, as well as providing for a lighter weight product as well.

The materials of the present invention may be manufactured by a pultrusion process, the mechanics of which are familiar to those of skill in the art. The process utilizes continuous Twintex fibers (roving or yarn), and other fiber as necessary, in order to process uniaxially reinforced profiles with exceptional longitudinal strength. Modification of the basic process allows for the incorporation of transverse reinforcements. Important components of the pultrusion process are: (1) heating, wherein the thermoplastic fibers are melted, and (2) the consolidation and shape forming at the tooling die, in which relatively high pressure is involved.

In a further preferred embodiment, the commingled, continuous filaments of glass fibers and polymeric fibers include from about 40%-80% glass fiber content. These commingled, continuous filaments may further include carbon fibers and/or aramid fibers. Furthermore, a bulk molding compound may be made out of the commingled, continuous filaments of glass fibers and polymeric fibers. This bulk molding compound may be compression molded into particular building products, such as fence, rail, post and deck materials. The commingled, continuous filaments may be added through, e.g., a helical winding machine.

In a further preferred embodiment of the present invention, the bulk molding compound includes from about 20%-80% glass fiber content, or is diluted with an addition of polymeric pellets to a glass fiber content to 10%-20% in the final product, with a glass fiber content of about 15% preferred. The thermal expansion and contraction of the composite building material is controlled by the use of the bulk molding compound.

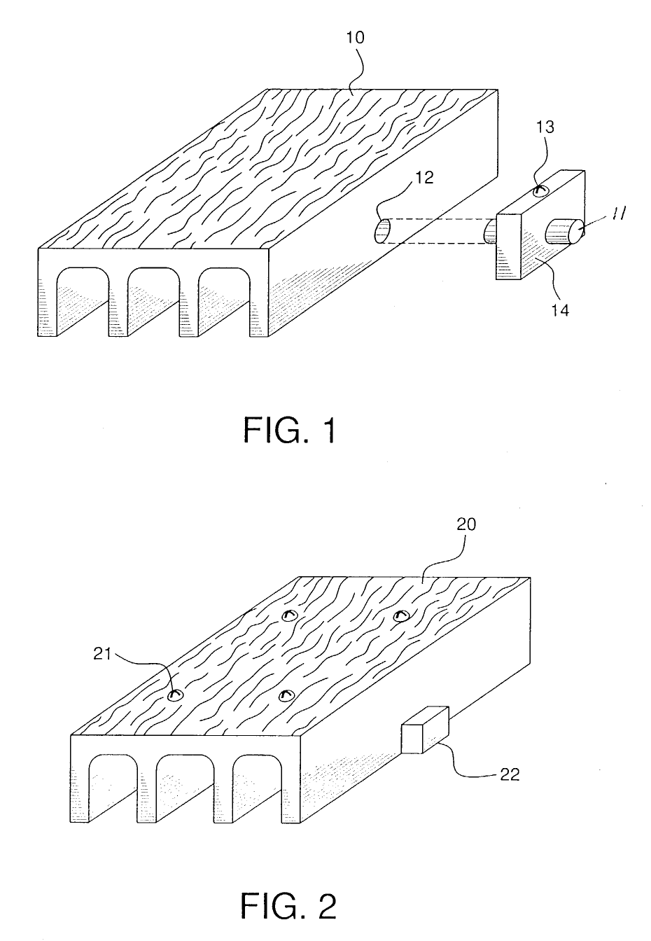

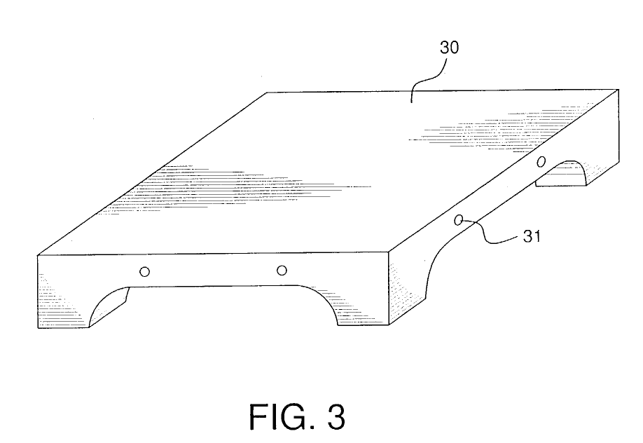

Wood-plastic composite panels commercially available have a stiffness of about 100,000 PSI. In order to match that stiffness, the present inventors incorporated one half inch to one inch long fiberglass of 10% at minimum with a profile height of about 1.25 to 1.5 inches. These dimensions will result in the composite material having a flexural modulus of about 400,000 PSI or higher. In a preferred embodiment, polymeric materials, specifically polypropylene copolymers with a melt index of about ten and higher, and formulated with a UV stabilizer and colorant, were tested. Note that other polymeric materials may be used for the purposes of the present invention, so long as such materials have an adequate melt index. Measurement of melt flow index was described in ASTM D1238. By incorporating fiberglass in the formulation by means of a bulk molding compound, the thermal expansion and contraction was reduced so that the dark brown color was no longer present. The thermal coefficient of linear expansion was reduced by more than ⅙, to about 1×10⁻⁵ inch/inch/° F. for the polypropylene copolymer. In reference to the figures, FIGS. 1 and 3 and FIG. 2 demonstrate differing ways by which the panels may be fastened to the substructure. In FIG. 2, screw fasteners 21 on the top of composite 20 provide the fastening function; relative to composites 10 and 30 as shown in FIGS. 1 and 3 respectively, a concealed fastener 14 with pin 11 is formulated to key into the side hole 12 of composite panel 10, and screwed into the substructure joist by screw 13. The pins act as spacers, while the concealed fasteners are necessary for the tiles.

Note that the preferred process for achieving the construction of the present invention is compression molding. The molding process provides a wood grain pattern of high quality. In operation, a fiberglass bulk molding compound is processed through a specially designed plasticator, and the billet is shuttled to a compression mold, and pressed. Note further that the plasticator is merely one type of compounding extruder equipped with a screw, designed to process the fiberglass in the bulk molding compound without breaking the fiberglass. Panel lengths produced by the compression molding process may range up to about 20 feet. The compression molding enables the surface of the panels to have customized patterns, as well as slip resistance called for by various industry codes.

Thus, the present invention relates to any walking panels or planks which have incorporated fiberglass of at least about ½ inch long, at about 10% to 40% by weight into a polymeric material of a melt index higher than e.g., about 2, in order to improve the impact strength for both “under room” and cold temperatures. Walking panels or planks with these characteristics may be made into any suitable custom colors, particularly dark colors, and serve to meet relevant building codes, performance criteria, deflection and creep resistance. Furthermore, a quality grain structure is achieved on the surface of the walking panels or planks, thereby controlling slip resistance.

The fiberglass component of the present invention may be chopped fiberglass, hybridized with other modulus enhancing fibers. In a further preferred embodiment, the walking panels or planks may have incorporated mold-in spacers, for ease of installation. Furthermore, the panels or planks of the present invention may be constructed of fiberglass bulk molding compound, using a compression molding process having a concealed fastener; such materials will make cutting easier by a power driven saw or other related device.

In a further preferred embodiment of the present invention, a rail of more than an eight foot span between the two posts, on a sixteen foot length encompassing two sections with, e.g., three posts with a Twintex reinforcement, is a possible alternative. The use of a hybrid reinforcement of Twintex commingled fiber and other reinforcement fibers, such as carbon fiber and/or aramid fibers is also possible.

Thus, the bulk molding compounds used for purposes of the present invention may be employed for compression molding into building products including fence, rail, post, deck, etc.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

We claim:

1. A process for providing a thermoplastic composite decking profile of continuous fiber reinforcement, which comprises including within said thermoplastic composite decking profile a polymer composite decking material, said polymer composite decking material comprising a commingled, continuous filament of glass fibers and polymeric fibers as reinforcement, wherein the polymeric fiber that becomes a consolidation matrix is a fiberizable polymer selected from the group consisting of polyethylene, polypropylene and polyesters.

2. The process as recited in claim 1, wherein the consolidation of the commingled fibers into composite reinforcement is made in-situ during in-line extrusion or pultrusion of the final end product.

3. The process as recited in claim 1, wherein the consolidation of commingled fibers into composite reinforcement is prepared as a tape or rod, and incorporated into an off-line extrusion of the final product.

4. The process as recited in claim 1, wherein the commingled, continuous filaments of glass fibers and polymeric fibers are incorporated through a cross-die head into a polymer extrudate.

5. The process as recited in claim 1, wherein the commingled, continuous filaments contain glass fibers dispersed uniformly in a longitudinal direction during extrusion or pultrusion.

6. The process as recited in claim 1, wherein the commingled, continuous filaments of glass fibers and polymeric fibers include from about 40%-80% glass fiber content.

7. The process as recited in claim 1, wherein the commingled, continuous filaments of glass fibers and polymeric fibers further include carbon fibers and/or aramid fibers.

8. The process as recited in claim 1, wherein a bulk molding compound is made of the commingled, continuous filaments of glass fibers and polymeric fibers.

9. The process as recited in claim 8, wherein the bulk molding compound made of the commingled, continuous filaments of glass fibers and polymeric fibers is compression molded into building products.

10. The process as recited in claim 9, wherein the building products are selected from the group consisting of fence, rail, post and deck materials.

11. The process as recited in claim 5, wherein the commingled, continuous filaments are added through a helical winding machine.

12. The process as recited in claim 8, wherein the bulk molding compound includes from about 20%-80% glass fiber content, or is diluted with an addition of polymeric pellets to a glass fiber content of 10%-20% in the final product.

13. The process as recited in claim 8, wherein the thermal expansion and contraction is controlled by the use of the bulk molding compound.
